(19) United States
(12) Patent Application Publication
(10) Pub. No.: US 2010/0046729 A1
(43) Pub. Date: Feb. 25, 2010

(54) Delivery of Call Features to a User Device Via a Multimedia Terminal Adapter

(75) Inventors: Louis D. Bifano, Morrisville, PA (US); Thomas F. Kister, Chalfont, PA (US); Jeffrey D. Ollis, Dresher, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/194,748

(22) Filed: Aug. 20, 2008

(51) Int. Cl. H04M 3/42

(52) U.S. Cl. 379/201.12

(57) ABSTRACT

Described herein are systems and methods for providing call features of a telephone service to a user device, such as a television set top box or a personal computer, by using a multimedia terminal adapter to establish a first network connection with a call management server (CMS) and a second network connection with an application server associated with the user device so as to receive and forward call features and requests for such call features between the CMS and the user device without the need for an interface between the CMS and the application server.

### BACKGROUND

Digital set top boxes (STBs) have been widely in use to provide viewers with television programming services, such as cable and satellite television services. Recent advent of voice-over-internet-protocol (VoIP) telephone services, internet-protocol television (IPTV) services, and the push for convergence of digital technologies also have given rise to new STBs that are capable of providing consumers with both video programming and telephone services. For example, some existing STBs can provide users with both telephone and television services and the ability to display caller identification (caller ID) during television viewing.

Traditionally, call functions or features such as call notifications (e.g., caller ID), voicemail playback, and forwarding calls to voicemail are offered by a telephone service provider (e.g., a local telephone company). As referred herein, a call feature is any feature or function relating to a telephone call that is made available to a participant in the call. Also traditionally, television services such as cable or satellite television subscription, pay-per-view, and video-on-demand are offered by a television service provider (e.g., a cable or satellite television provider) via a STB. Thus, to integrate telephone services as provided by a telephone service provider into an STB that is administered by a television service provider, there is currently a requirement for the television service provider to maintain a telephony application server that can interact with a call management server (CMS) at the telephone service provider so as to process various call functions for transmission to the appropriate STB. As referred herein, a CMS monitor telephone calls handled by a designated telephone network, such as the telephone network of the telephone service provider, and provide call functions or features relating to such telephone calls. However, integration with the CMS may be problematic because a business relationship between the television service provider and the telephone service provider often does not exist. Additionally, technical difficulties may be encountered with provisioning the CMS to send call notifications to the telephony application server. This is because there is no standard interface to the CMS, and each CMS may require a customized interface to which the television service provider may not have access.

### BRIEF DESCRIPTION OF THE DRAWINGS

Embodiments are illustrated by way of example and not limited in the following figure(s), in which like numerals indicate like elements, in which:

FIG. 1 illustrates an example of a system for providing television programming and telephone services to set top boxes (STBs) at remote user locations;

FIG. 2 illustrates an example of a multimedia terminal adapter (MTA) that may be implemented in a gateway device;

FIG. 3 illustrates a process or method for delivering call features to a user device via a MTA.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

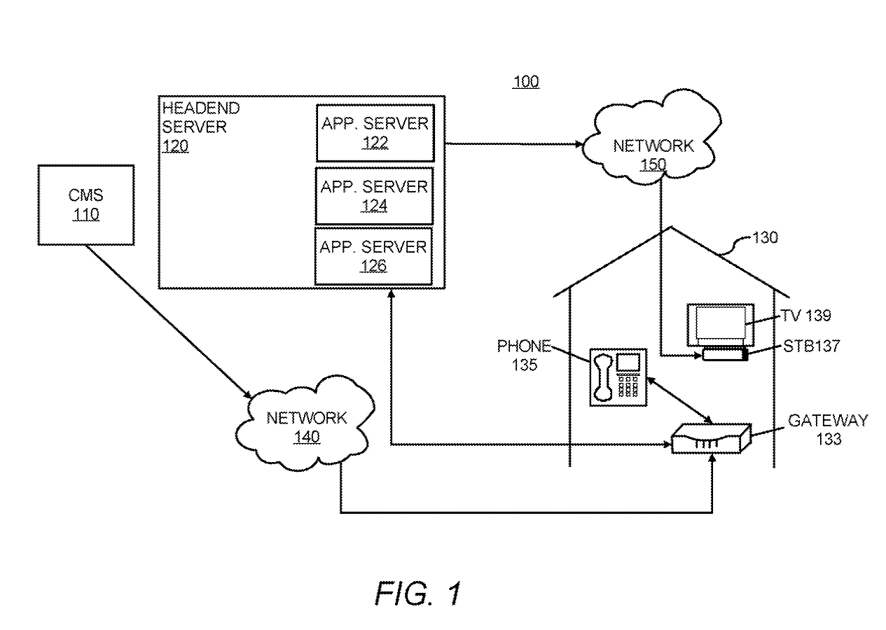

Described herein are systems and methods for delivering various call functions or features to television viewing devices, such as set top boxes (STBs), via a multimedia terminal adapter without the need for interfacing an application server that services the user devices with a call management server (CMS) that provides the call notifications. As referred herein, a call notification includes an audio and/or visual notification of an incoming telephone call to a designated location. Examples of a call notification include an audio chime and/or a visual display of the caller ID of an incoming telephone call to the user location 130 (FIG. 1A).

FIG. 1 illustrates an example of a system 100 for providing television programming and telephone services to STBs at remote user locations. The system 100 includes a headend facility 120 maintained or hosted by a television service provider (e.g., a cable or satellite television provider), a call management server (CMS) 110 maintained or hosted by a telephone service provider (e.g., a VoIP telephone service provider or a plain old telephone service, or POTS, provider), and one or more STBs 137 located at a user location 130 (e.g., home, residence, lodging unit, or any other customer's premise).

The headend facility 120 includes one or more headend servers that is operable to capture the user's subscription to a television programming service and provide associated television programming content to the user location 130 via a network 150, such as a hybrid fiber-coaxial (HFC) network for a cable television service, an IP network like the Internet for an IPTV service, or a terrestrial network for a satellite television service. The headend facility 120 is also operable to capture the user's subscription to the telephone service by registering each STB 137 at the user location 130 and correlating such STB(s) with one or more phone numbers used by the telephone 135 at the user location 130. To that effect, the headend facility 120 may include therein one or more application servers for administering the telephone service, and call features thereof, as provided by the CMS 110 and received via the gateway device 133 (through a MTA therein). Three application servers 122, 124, and 126 are shown in FIG. 1 for illustrative purposes only and not to be limiting thereof. The application servers may communicate with the STB 137 via the same network 150 used by the headend servers to communicate with STB 137 to separately or concurrently provide call features and television programming content provided by the headend servers. Alternatively, the application servers may use a different network to communicate with the STB 137 to separately or concurrently provide call features and television programming content provided by the headend servers.

The CMS 110 is operable to provide telephone service to the user location 130 via a network 140. In the first scenario wherein the provided telephone service is a POTS, the network 140 may be the conventional public switched telephone network (PSTN). In the second scenario wherein the provided telephone service is a VoIP service, the network 140 may be an IP network, such as the public Internet or a private dedicated IP network provided by the telephone service provider. In the second scenario, the user location 130 further includes a gateway device 133 to which a telephone 135 may be connected to receive the VoIP service. The gateway device 133 may be an embedded multimedia terminal adapter (E-MTA) or may represent a modem and a separate standalone multimedia terminal adapter (S-MTA) that is in communication with the network 140 via the modem to enable the telephone 135 connected thereto to receive the VoIP service provided via the CMS 110. Thus, the MTA (E-MTA or S-MTA) of the gateway device 133 is provisioned or configured with an address, such as an Internet Protocol (IP) address, of the CMS 110 to provide telephone services to the telephone 135. For illustrative purposes only and not to be limiting thereof, FIG. 1 shows the gateway device 133 as an E-MTA.

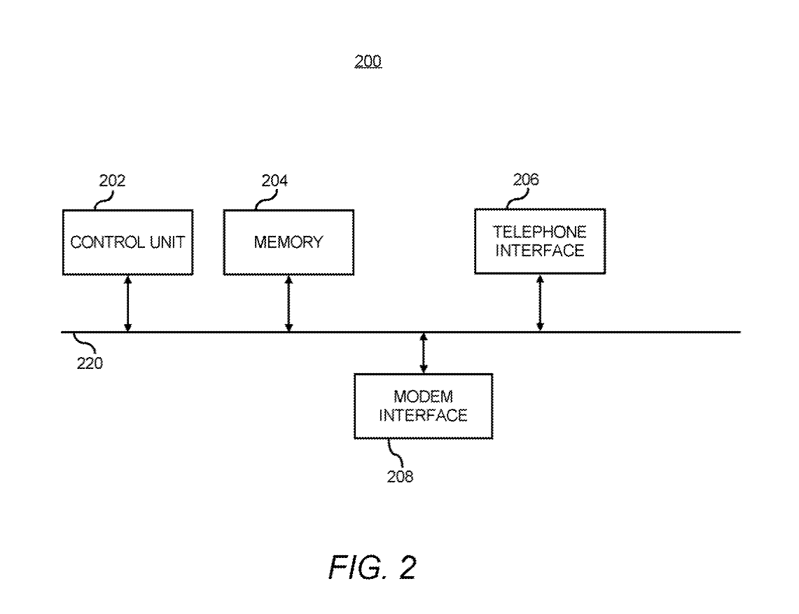

FIG. 2 illustrates an example of a MTA 200 that may be implemented in the gateway device 133. The MTA 200 includes a control unit 202 having one or more processors to provide an execution platform for executing software. Thus, the control unit 202 may include one or more single-core or multi-core processors of any of a number of computer processors, such as processors from Intel, AMD, and Cyrix. As referred herein, a processor may be a general-purpose processor, such as a central processing unit (CPU) or any other multi-purpose processor or microprocessor. A processor also may be a special-purpose processor, such as a digital signal processor, or another processor dedicated for one or more processing purposes. Commands and data from the processor 202 are communicated over a communication bus 220 (as shown in FIG. 2) or through point-to-point links with other components in the MTA 200.

The MTA 200 also includes an analog, or digital, telephone interface 206 that is operable to provide audio output to and receive audio input from a conventional analog, or digital, telephone (not shown) and a modem interface 208 that is operable to send and receive data from a modem (e.g., cable or DSL modem) in the gateway device 133 for conveyance over an IP network, such as the network 140 or 150. The MTA 200 further includes a memory 204 that may be implemented as a computer readable medium (CRM). Examples of a CRM include but are not limited to an electronic, optical, magnetic, or other storage device capable of storing data content and providing a processor, such as one in the control unit 102, with software, i.e., computer-readable instructions or executable codes. Other examples of a suitable CRM include but are not limited to a floppy disk, CD-ROM, DVD, magnetic disk, memory chip, ROM, RAM, an ASIC, any optical medium, any magnetic tape or magnetic medium, or any other medium from which a processor is operable to read instructions. In operation, the control unit 202 performs audio coder-decoder (CODEC) functions by executing CODEC software stored in the memory 204 to convert voice signals received from a telephone at the telephone interface 206 to digital data, such as IP packets, and forwards such data to a modem at the modem interface 208 for conveyance over an IP network, such as the network 140 or 150. The control unit 202 also performs CODEC functions to receive digital data, such as IP packets, from the IP network via the modem and convert such data to voice signals for conveyance to the telephone for the user to hear in a telephony communication.

In addition to being typically provisioned or configured with an address, such as an IP address, of the CMS 110 for communicating therewith, the MTA of the gateway device 133 is provisioned or configured with an address, such as an IP address, of a designated application server in the headend facility 120. The designated application server is used to provide various telephone functions or features as noted earlier. A number of methods may be used to provision or configure the MTA. For example, a dynamic host configuration protocol (DHCP) offer may be used to provide the MTA with the IP address or an Internet domain name of the application server. In a typical DHCP offer, a network administrator or operator at the headend facility 120 administers an IP address and other network parameter assignments to the gateway device 133 so that the gateway device 133 becomes a part of a network with the headend facility 120 and its application servers therein. Thus, the DHCP offer may be extended to include additional information such as an IP address or Internet domain name of the corresponding application server that is provided to the gateway device 133 so that it may be configured to communicate with such an application server via the provided server IP address. In the case of a provided Internet domain name of the application server, an Internet domain name system (DNS) lookup may be performed by the gateway device 133 to obtain the actual IP address of the application server. The provided server IP address or Internet domain name may e stored in the memory 204.

In another example, once the gateway device 133 is assigned an IP address for networking with the headend facility 120, such as through a DHCP offer, a configuration file may be forwarded to the IP address of the gateway device 133. The configuration file may be forwarded by the headend facility 120 or the corresponding application server, and it includes an IP address or Internet domain name of the application server so that the gateway device 133 may be configured to communicate with one of the application servers via the server IP address. Again, in the case of a provided server domain name, a DNS lookup may be performed to obtain the actual IP address of the application server. The provided configuration file may be stored in the memory 204 of the MTA (which is included in the gateway device 133). In still another example, the IP address or Internet domain name of the application server may be hard-coded in (e.g., in the firmware) the MTA of the gateway device 133 so that it may communicate with the application server via the server IP address. Again, if a server domain name is hard coded, a DNS lookup may be performed to obtain the actual IP address of the application server.

In one embodiment, the configuration file may include additional instructions to the gateway device 133, or MTA therein, on how to properly communicate telephone functions or features, such as call notifications or other call features, (as received from the CMS 110) to the application server. For example, the configuration field may include a mapping or translation of call-feature codes as received by the MTA from the CMS 110 to corresponding call-feature codes or formats understood by the MTA so that the MTA can provide the proper call features to the STB 137. In another embodiment, the MTA may forward the call-feature codes as received from the CMS 110 to the application server, which then performs the mapping or translation to call-feature codes or formats that can be forwarded to, and understood and performed by the STB 137.

Once provisioned or configured with an address of the application server, the MTA is operable to send call notifications to an application server in the headend facility 120 whenever it receives a call from the CMS 110, whereupon the application server is operable to send such a call notification to the STB 137 to perform various call functions or features such as displaying caller IDs on the TV 139 or enables the user to forward calls to a voicemail. Because the MTA is configurable to deliver call notifications to the application server upon receiving them from the CMS 110, this setup enables call notifications to be delivered to the STB 137 or any other user device, such as a personal computer, ahead of the call notification, such as a phone ringing, at the phone 135.

Accordingly, an interaction between the CMS 110 and the MTA (represented by the gateway 133) is maintained to offer call functions or features to the STB 137 without the need to modify the CMS 110 or the application server in the headend facility 120 so that they can be provisioned or configured to interface with one another. That is, while the CMS 110 may have a customized or proprietary interface, it does not affect the ability of the STB 137 to provide the user with call functions, so long as the MTA remains operable to interface with the CMS 110. In practice, because the MTA is typically offered by the same telephone service provider that also maintains or hosts the CMS 110 or configured for call features provided by such a provider, an interface between the MTA and the CMS 110 is operable.

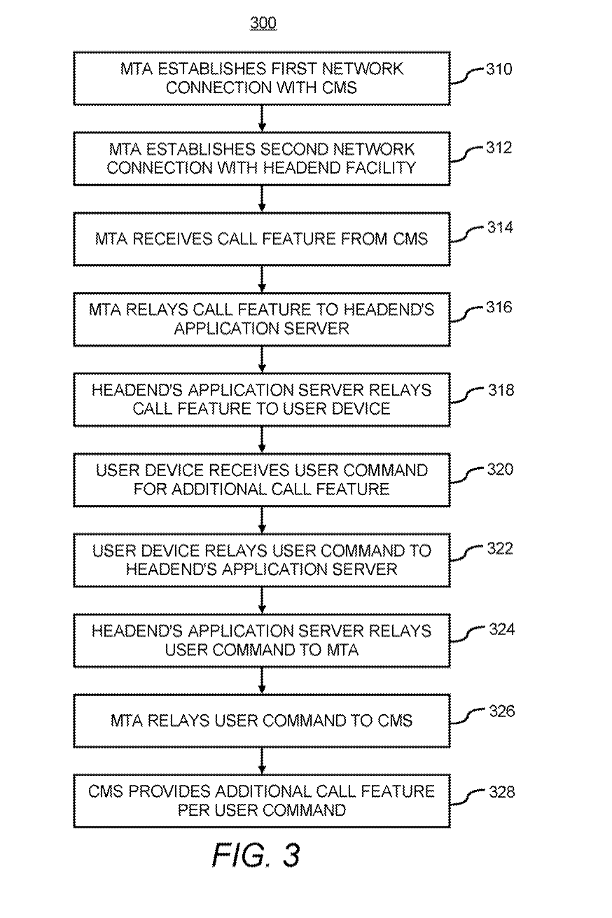

FIG. 3 illustrates a process or method 300 for delivering call features to a user device, such as a STB or a personal computer, as provided by a telephone service provider via a MTA to avoid direct interaction between the telephone service provider and a service provider for the user device. For example, if the user device is a STB, the service provider for such a device is a cable or satellite television provider. For illustrative purposes only and not to be limiting thereof, the method 200 is described in the context of the system 100. Also, the MTA as described in this process is a part of the gateway device 133 with details as described earlier. Thus, any network communication or connection thereto by the MTA in the process 200 is performed via a modem that is coupled to or integrated with the MTA to form the gateway device 133.

At 310, the MTA in the gateway device 133 establishes a first network connection with the CMS 110 via a network 140. The CMS 110 is hosted or maintained by a telephone service provider. Similar to an earlier description with respect to the headend facility 120, a network administrator or operator at the CMS 110 may employ a DHCP offer, or any suitable method, to assign the gateway device 133 with an IP address recognizable to the CMS 110. Also, the gateway device 133 is provided with an IP address of the CMS 110 as described above with regard to the headend facility 120, or in any manner currently known or will be known in the art, to effect the network connection with the CMS 110. With an assigned address and a known address for the CMS 110, the MTA is operable to establish a network connection with the CMS 110.

At 312, the MTA also establishes a second network connection, via the network 150 or a different network, with the headend facility 120, particularly, a designated application server in the headend facility 120 that provides call functions to the user device, such as the STB 137. As with the first network connection above, the MTA is provisioned with an address assignment, such as an IP address assignment, that is recognizable to the headend facility 120. The MTA is also provisioned (via a configuration file as noted earlier) with an address, such as an IP address, of the designated application server in the headend facility 120 to effect the second network connection with the headend facility 120.

At 314, through the established first network connection with the CMS 110, the MTA receives a call feature or function from the CMS 110. For example, a call notification of an incoming call to the telephone 135 is received at the gateway device 133, wherein the call notification includes caller ID information.

At 316, through the established second network connection with the headend facility 120, the MTA relays, or forwards, the call feature to the application server. For example, the MTA forwards the call notification to the application server in the headend facility 120. In one embodiment, as noted earlier, the MTA may provide a mapping or translation of the call feature code, such as the call notification code, as received from the CMS 110 to a corresponding call feature code that can be understood by the application server so as to effect such a call feature at the STB 137. In another embodiment, as also noted earlier, such code mapping or translation may be performed by the application server. Thus, in such an embodiment, there is an intermediate step between 316 and the following 318, wherein the application server performs the mapping or translation.

At 318, the application server relays or further forwards, via the network 150, the call feature to a designated user device at the user location 130 for processing. For example, the application server relays the aforementioned call notification to the STB 137, which may then display the call notification on a display such as a television 139. In one embodiment, the gateway device 133 may provide a predetermined time delay before notifying the telephone 135 of the incoming call so that the call notification may be displayed on the television 139 at about the same time as the telephone 135 rings to indicate an incoming call. It should be noted that the established second network connection between the MTA and the headend facility 120 may use the same or different (as illustrated in FIG. 1) network connection between the STB 137 and the headend facility 120 and its application servers therein.

At 320, a user at the STB 137 may desire to access one or more additional call features made available by the CMS 110. For example, upon being notified of an incoming call by the STB 137, the user may access the STB 137 via a user interface, such as a remote control, to issue a user command to forward the incoming call to voicemail, which may be stored at the CMS 110.

At 322, the application server receives the user command from the STB 137. This user command may be transmitted back to the application server via the network 150 or via a separate connection, such as through a phone line or an Internet connection as is typically used for such an uplink from the STB 137 back to the headend facility 120.

At 324, through the established second network connection between the gateway device 133 and the application server in the headend facility 120, the application server relays the user command to the MTA.

At 326, through the established first network connection, the MTA relays the user command to the CMS 110.

At 328, the CMS 110 complies with the user command and provides the call feature requested in the user command. For example, the CMS 110 activates the user's voicemail to record the incoming call for the user, whereby the voicemail is saved in a memory area (e.g., a CRM) in the CMS 110, or in any other location designated by the telephone service provider that maintains or hosts the CMS 110. The CMS 110 may also stop the call notification of the incoming call.

Subsequently, the user may wish to listen to the voicemail through the STB 137. In such a case, the process 200 may start at 320, wherein the user activates the telephone feature of voicemail playback using the STB 137 as noted above and ends at 328, wherein the CMS 110 provides the call feature that requested in the user command, namely, the CMS 110 provides the voicemail playback. The process 200 has been described wherein the MTA of the gateway device 133 provides various call features to a user device such as a television STB via an application server provided at the headend facility 120. However, alternative embodiments are contemplated wherein the MTA may provide the various call features to the user device without an intervening entity such as the headend facility 120 or its application servers therein.

Accordingly, the systems and methods as described above employs a MTA to enable call features to be provided to a user device independent of any interaction between the user device or its application server with a CMS that provides such call features. Thus, the CMS network interface may be customized or revised without affecting the ability of the user device to receive the call features from the CMS. Similarly, any customization or revision of the network interface at the user device or its application server does not affect the ability of the user device to receive the call features from the CMS either.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for providing call features to a user device, comprising:
establishing a first network connection with a call management server (CMS);
establishing a second network connection with an application server;
receiving, through the first network connection, a call feature from the CMS; and
forwarding, through the second network connection, the received call feature to the application server.

2. The method of claim 1, wherein the step of establishing the first network connection comprises:
provisioning a multimedia terminal adapter (MTA) with an address of the CMS; and
establishing the first network connection between the MTA and the CMS based on the address of the CMS as provisioned to the MTA.

3. The method of claim 2, wherein the step of establishing the second network connection comprises:
provisioning the MTA with an address of the application server; and
establishing the second network connection between the MTA and the application server based on the address of the application server as provisioned to the MTA.

4. The method of claim 2, wherein the address of the CMS as provisioned to the MTA is one of an Internet Protocol (IP) address and an Internet domain name of the application server.

5. The method of claim 3, wherein the address of the application server as provisioned to the MTA is one of an Internet Protocol (IP) address and an Internet domain name of the application server.

6. The method of claim 1, wherein the step of forwarding the received call feature comprises:
forwarding, through the second network connection, the received call feature to the application server; and
the user device receiving the call feature from the application server.

7. The method of claim 6, wherein the call feature is a call notification of an incoming call to a telephone, and the user device is a television set top box (STB), the method further comprising:
enabling the television STB to display the call notification along with television programming.

8. The method for providing call features to a user device, comprising:
providing a multimedia terminal adapter (MTA) for a telephone service;
providing a call management server (CMS) to handle the telephone service provided to the MTA;
receiving an address of an application server associated with the user device;
provisioning the MTA with the address of the application server as received;
forwarding a call feature associated with the telephone service from the CMS to the MTA; and
enabling the MTA to further forward the call feature to the application server based on the address of the application server provisioned to the MTA.

9. The method of claim 8, further comprising:
receiving at the CMS a user command for an additional call feature from the MTA, wherein the user command originates from the user device.

10. The method of claim 9, further comprising:
forwarding the additional call feature requested by the user command from the CMS to the application server, via the MTA.

11. A method for providing call features to a user device, comprising:
providing an application server to process call features;
establishing a first communication connection for the application server to communicate with the user device;
providing an address of the application server to a multimedia terminal adapter (MTA);
establishing a second communication connection with the MTA based on the provided address;
receiving at the application server, through the second communication connection, a first call feature from the MTA; and
forwarding, through the first communication connection, the first call feature from the application server to the user device.

12. The method of claim 11, further comprising:
receiving at the application server, through the first communication connection, a command from the user device for a second feature;
forwarding, through the second communication connection, the command from the application server to the MTA;
receiving the second feature, through the second communication connection, the second feature requested in the command; and
forwarding, though the first communication connection, the second feature from the application server to the user device.

13. The method of claim 11, further comprising:
providing a headend server to provide programming content to the user device; and
forwarding, through the first communication connection, the programming content from headend server to the user device in concurrent with the forwarding of the first call feature from the application server to the user device.

14. The method of claim 1, further comprising:
mapping the call feature as received from the CMS into a predetermined format for the application server; and
the step of forwarding includes forwarding, through the second network connection, the mapped call feature to the application server.

15. The method of claim 8, further comprising:
enabling the MTA to map the call feature as forwarded from the CMS to a predetermined format for the application server; and
the MTA forwarding the call feature in the predetermined format as mapped to the application server.
